(19) United States
(12) Patent Application Publication
(10) Pub. No.: US 2023/0052789 A1
(43) Pub. Date: Feb. 16, 2023

(54) ISOLATING OPERATING SYSTEM ENVIRONMENTS IN EMBEDDED DEVICES

(71) Applicant: Microsoft Technology Licensing, LLC, Redmond, WA (US)

(72) Inventors: Ryan James FAIRFAX, Kirkland, WA (US); Galen Clyde HUNT, Bellevue, WA (US); Barry Clayton BOND, Redmond, WA (US); Kevin Thomas WESTON, JR., Redmond, WA (US)

(21) Appl. No.: 17/401,236

(22) Filed: Aug. 12, 2021

(51) Int. Cl. G06F 9/455

(52) U.S. Cl. CPC G06F 9/45558; G06F 9/4555; G06F 2009/45562; G06F 2009/45587

(57) ABSTRACT

A unique embedded system is disclosed that locally operates an application virtual machine (VM) and a system VM in isolation from each other. The application VM executes application-specific code for a given purpose of the embedded system. The system VM executes a host operating system (OS) and various security, compatibility, and updating functions independent of the application VM. Each VM is connected to its own unique hardware on the embedded system to ensure that changes to the application code or the system code do not impact the other.

### BACKGROUND

Operating systems (OSes) control virtually all of today's networked devices. Everything from personal computers to virtual reality (VR) headsets to Internet of Things (IoT) devices run an OS to provide a software environment in which application-specific code may be deployed. Yet, devices in the area of embedded systems typically run on a system on a chip (SoC), controller, or other processing chip with a limited amount of memory and other hardware. With memory and processing resources constrained, the OSes running on embedded systems must be efficient.

Purpose-built embedded systems (e.g., smart appliances, IoT devices, etc.) have the limited amounts of memory and other hardware that must be strategically used. These types of devices have small amounts of memory, short run times, and shared libraries. Not only that, but they also include an OS environment that controls things like networking, security, and compatibility and also application-specific code that controls how the end device operates, collects data, and generally functions. For example, an embedded system may include an OS to connect a smart appliance to the network, prevent it from being hacked, and be able to be updated and also instructions that provide remote monitoring for the appliance, make it is not running when it should not be, or other functions specific to the appliance. Using the same hardware on the embedded system for both the OS instructions and the application-specific instructions exposes vulnerabilities of one to the other.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Examples and implementations disclosed herein are directed to an embedded system configured to perform application-specific instructions. The embedded system includes an application virtual machine (VM) and a system VM that operate locally in isolation from one another. Hardware and software on the embedded system are only connected to one VM or the other—the application VM or the system VM—isolating the two VMs from each other. And each VM runs its own software versions and components. This ensures that changes to the application code or the system code do not impact the other.

### BRIEF DESCRIPTION OF THE DRAWINGS

The disclosed examples are described in detail below with reference to the accompanying drawing figures listed below:

FIG. 1 illustrates a block diagram of an example embedded system, according to some of the disclosed implementations;

FIG. 2 illustrates a block diagram of a networking environment for operating a cloud-connected embedded system, according to some of the disclosed implementations;

FIG. 3 illustrates a generalized block diagram of an embedded system with a partitioned application VM and system VM, according to some of the disclosed implementations;

FIG. 4 illustrates a detailed block diagram of an embedded system with a partitioned application VM and system VM, according to some of the disclosed implementations; and

FIGS. 5-6 illustrate flow chart diagrams detailing a workflows for creating embedded system with an application VM isolated from a system VM, according to some of the disclosed implementations.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As referenced herein, an “embedded system” refers to an end computing device that has a combination of a computer processing unit (e.g., SoC, controller, microcontroller, microprocessor, or the like); computer memory; and hardware I/Os, peripherals, sensors, or other hardware components that collectively function for an intended purpose. It may be “embedded” as part of a complete device often including electrical or electronic hardware and mechanical parts. Because an embedded system typically controls physical operations of the machine that it is embedded within, it often has real-time computing constraints. For example, a smart appliance may include various embedded systems that control operation or remote connection. A factory robot may have a sensor that monitors parts on a conveyor belt. Myriad other examples exist.

Today's embedded systems traditionally have a small amount of memory compared to general computer systems. With embedded systems moving into the cloud, complex OSes are needed to communicate over networks that consume even more of the local memory space. Not only that, but security and compatibility changes of these complex OSes often cause chip malfunctions because the embedded system uses the same memory spaces for OS and other system operations as well as application-specific operations. For example, an IoT device may only have 16 MB or memory that are continually used to load and erase both OS and application-specific operations. This limited memory combined with the larger demands of a modern OS have left many device developers operating close to the limit. Some developers even run the embedded system out of memory and then back off so they use all they can. This has put the OS in a precarious position as any small updates may change memory characteristics in such a way that breaks a customer application scenario that worked on a previous version.

Additionally, OS developers spend significant time investing in building APIs, curating libraries, and providing custom services to enable application authors to build desired experiences. For microcontroller units (MCU), developers are expected to bring their own libraries and own maintenance and security patching of them. Libraries are often statically linked so servicing a library includes updating the core app that uses them. For example, in LINUX, the OS provides libraries via some form of package manager and that servicing of a library involves updating the core OS and not device-specific applications.

This poses a few challenges for developers who create application-specific programs to run on embedded systems. First, developers cannot easily bring existing open source software (OSS) unless it happens to line up with application programming interfaces (APIs) exposed by the particular software development kit (SDK) of the SoC, controller, or processor of the embedded system. This limits usage of the existing ecosystem of libraries and OSS. Second, the libraries that are exposed must have hard compatibility guarantees that impact upgrade strategies and security fixes. In the Linux world, this is often solved by shipping multiple versions of a library, which has limited lifetime in desktop and server deployments. Developers need to be able to pull in existing open source or code to run for years in today's embedded systems, and the current offerings are stretched to their limits attempting to provide that support.

Moreover, in the MCU world, developers are used to interfacing directly with peripheral hardware. This has a higher development cost as drivers must be written for each SoC but, in turn, it gives maximum control and performance to the developer. For LINUX, device drivers and abstractions simplify developing an application that uses peripherals at the expense of performance.

To ensure compatibility and security, the disclosed implementations and examples describe embedded systems that provide separate partitioned VMs for system software to evolve independently from application software. In particular, the disclosed implementations and examples are directed to embedded systems that isolate application-specific code from the system OS using at least two partitioned virtual machines (VMs). An application VM is created that runs the application-specific code for the end device, and a system VM is created that runs more generalized system operations, such as a networking stack, OS, and software update functions. Shared resources and operations eliminated or at least dramatically minimized as much as possible, allowing customers to get their application workloads running on the disclosed embedded systems quickly and without friction.

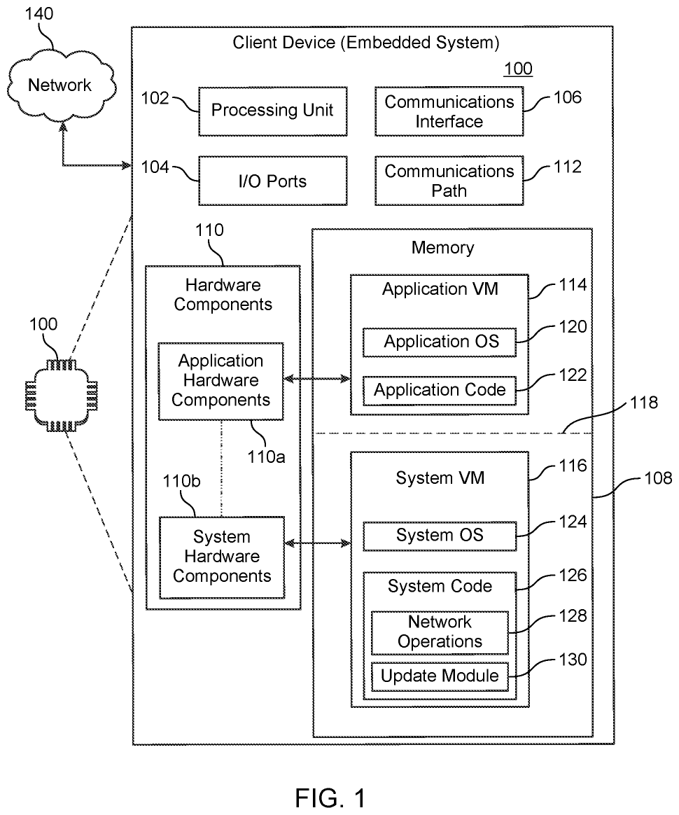

FIG. 1 illustrates an example of an embedded system, shown as client device 100, configured to receive an OS build with hardware driver bindings and instances for resident hardware components in accordance with some of the embodiments disclosed herein. Client device 100 is an embedded system that includes one or more processing units 102, input/output (I/O) ports 104, a communications interface 106, computer-storage memory (memory) 108, hardware components 110, and a communications path 112—all of which constitute hardware components with drivers and presence in one or more device trees. Client device 100 may take the form any number of computing devices, such as smart sensor, IoT device, application-specific integrated circuit (ASIC), or other device that engineered and programmed for a specific functional purpose. Client device 100 is but one example of a suitable computing environment and is not intended to suggest any limitation as to the scope of use or functionality of the disclosed embodiments.

The processing unit 102 may include any type of ASIC, SoC, microcontroller, MCU, controller, microprocessor, processor, analog circuit, or the like programmed to execute computer-executable instructions for implementing aspects of this disclosure. In some examples, the processing unit 102 is programmed to execute instructions such as those illustrated in the other drawings discussed herein. For purposes of this disclosure, the terms “processor,” “controller,” “MCU,” “processing unit,” and “control unit” are meant to connote the same thing and are used interchangeably.

Client device 100 is equipped with one or more hardware components 110. Hardware components 110 refer to the specific hardware that is connected to or resident on client device 100. Examples of hardware components 110 include, without limitation, transceivers (e.g., UART); displays (e.g., touch, VR or augmented reality (AR), etc.); peripherals (e.g., stylus, wearable, etc.); sensors (e.g., accelerometer, inertial movement unit (IMU), gyroscope, global positioning system (GPS), magnetometer, etc.); microphones; speakers; or any other hardware. Any combination of hardware may be incorporated in client device 100.

I/O ports 104 provider internal and external connections for the hardware components 110. Hardware components 110 use the I/O ports 104 to operate externally and internally.

Communications interface 106 allows software and data to be transferred between client device 100 and external devices over a network 140. Examples of communications interface 106 may include a modem, a network interface (such as an Ethernet card), a communications port, a Personal Computer Memory Card International Association (PCMCIA) slot and card, a BLUETOOTH® transceiver, radio frequency (RF) transceiver, a near-field communication (NFC) transmitter, or the like. Software and data transferred via the communications interface 106 are in the form of signals that may be electronic, electromagnetic, optical or other signals capable of being received by communications interface 106. Such signals are provided to the communications interface 106 via the communications path (e.g., channel) 112. This communications path 112 carries the signals and may be implemented using a wired, wireless, fiber optic, telephone, cellular, radio frequency RF, or other communication channel. The communications interface 106 and the I/O ports 104 are shown separate from the hardware components 110, even though they are shown separately.

The hardware components 110 are logically discussed herein as being application hardware components 110a and system hardware components 110b, meaning they are either logically connected to application-specific code (discussed in more detail below as application code 122) or system-specific code (discussed in more detail below as system code 126. For the disclosure, “logically connected” may include physically connected, electrically connected, or able to communicate via signaling (e.g., through radio waves, wirelessly, light, infrared, or the like). The hardware components 110 may be used by either the application code 122 or the system code 126, but those two portions of code (application code 122 and system code 126) are isolated from one another using different VMs that establish a partition 118, as discussed in more detail below.

Network 140 may include any computer network or combination thereof. Examples of computer networks configurable to operate as network 140 include, without limitation, a wireless network; landline; cable line; digital subscriber line (DSL): fiber-optic line; cellular network (e.g., 3G, 4G, 5G, etc.); local area network (LAN); wide area network (WAN):, metropolitan area network (MAN); or the like. The network 140 is not limited, however, to connections coupling separate computer units. Rather, the network 140 may also comprise subsystems that transfer data between servers or computing devices. For example, the network 140 may also include a point-to-point connection, the Internet, an Ethernet, an electrical bus, a neural network, or other internal system. Such networking architectures are well known and need not be discussed at depth herein.

Computer-storage memory 108 includes any quantity of memory devices associated with or accessible by the client device 100. The computer-storage memory 108 may take the form of the computer-storage media references below and operatively provide storage of computer-readable instructions, data structures, program modules and other data for the client device 100 to store and access instructions configured to carry out the various operations disclosed herein. The computer-storage memory 108 may include memory devices in the form of volatile and/or nonvolatile memory, removable or non-removable memory, data disks in virtual environments, or a combination thereof. And computer-storage memory 108 may include any quantity of memory associated with or accessible by the client device 100. Examples of client device 100 include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other computer memory.

The computer-storage memory 108 may be internal to the client device 100 (as shown in FIG. 1), external to the client device 100 (not shown), or both (not shown). Additionally or alternatively, the computer-storage memory 108 may be distributed across multiple client devices 100 and/or servers, e.g., in a virtualized environment providing distributed processing. For the purposes of this disclosure, “computer storage media,” “computer-storage memory,” “memory,” and “memory devices” are synonymous terms for the computer-storage media 108, and none of these terms include carrier waves or propagating signaling.

The client device 100 is configured to operate for a given purpose. For example, a smart appliance may provide appliance capabilities, an industrial robot may monitor parts on an assembly line, security sensor may alert authorities when particular sounds are detected, etc. IoT devices have myriad uses, far too many to exhaustively list in this disclosure. To carry these out, the client device 100 has specific application code 122 that performs application-specific functions (e.g., appliance functions, computer vision for assembly line monitoring, security operations, etc.). Additionally, the client device 100 includes an application OS 114 in which the application code 122 executes.

Additionally, the client device 100 includes various system operations that are shown as system code 126 executing in a system OS 124. The system operations include, without limitation, networking operations 128, compatibility operations, security operations, an updating module 130, and other non-application-specific operations. In particular, the network operations 128 include a network stack for communicating with remote devices in a cloud environment, and the update module 130 include instructions for updating the various OSes and the application code 122 of the client device 100.

To keep the application-specific operations of the client device 100 separate from the system operations, the disclosed implementations and examples provision two or more separate VMs on the client device: an application VM 114 and a system VM 116. The application VM 114 includes the application OS 120 and the application code 122. The system VM includes the system OS 124 and the system code 126. These two VMs (114 and 116) run independently of each other, effectively creating a partition 118 therebetween. In some examples, the application VM 114 and the system VM 116 are provisioned on the client device 100 by the manufacturer of the processing unit 102. For example, a chip manufacturer may program the processing unit 102 (e.g., SoC, chip, MCU, etc.) and memory with the application VM 114 and the system VM 116 before being shipped to end users.

The application VM 114 and the system VM 116 are connected to their own hardware components 110. As depicted, the application VM 114 is only connected to a specific subset of hardware components 110: application hardware components 110a. And the system VM 116 is only connected to a specific subset of hardware components 110: system hardware components 110b. In some implementations, the application VM 114 and the system VM 116 cannot access the other's hardware components 110. To clarify, the system VM 116 is not connected to the application hardware components 110a, and the application VM 114 is not connected to the system hardware components 110b. For instance, the application VM 114 may be connected to a flash drive of memory as part of the application hardware components 110a, and thus, only the application VM 114 may access that flash memory—not the system VM 116. Similarly, the system VM 116 may be connected to a Wi-Fi adapter as part of the system hardware components 110b that is not accessible by the application VM 114. This ensures that updates to either the application code 122 do not affect operation of the system code 126, and vice versa.

The disclosed OSes—the application OS 120 and the system OS 124—may be may be any OS designed to control the functionality of client device 100, including, for example but without limitation: WINDOWS® developed by the MICROSOFT CORPORATION® of Redmond, Wash.; MAC OS® developed by APPLE, INC.® of Cupertino, Calif.; ANDROID™ developed by GOOGLE, INC.® of Mountain View, Calif.; open-source LINUX®; or the like. In some embodiments, the application OS 120 and the system OS 124 are embedded OSes for running on an embedded system. Embedded OSes are typically designed to be resource-efficient, including functions that only operate on RAM or ROM of memory 108, which may be the only resident memory onboard. In such embodiments, the application OS 120 and/or the system OS 124 may be a real-time OS (RTOS).

The examples disclosed herein may be described in the general context of computer code or machine- or computer-executable instructions, such as program components, being executed by a computer or other machine. Generally, program components include routines, programs, objects, components, data structures, and the like that refer to code, performs particular tasks, or implement particular abstract data types.

Computing device 100 includes a bus 110 that directly or indirectly couples the following devices: computer-storage memory 112, one or more processors 114, one or more presentation components 116, I/O ports 118, I/O components 120, a power supply 122, and a network component 124. While computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory.

Memory 112 may take the form of the computer-storage memory device referenced below and operatively provide storage of computer-readable instructions, data structures, program modules and other data for the computing device 100. In some examples, memory 112 stores one or more of an OS, a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif., ANDROID™ developed by GOOGLE, INC.® of Mountain View, Calif., open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, MCU, SoC, ASIC, or the like for isolating application operations from system operations.

Processor(s) 114 may include any SoC, MCU, controller, processor, processing unit that perform the various operations stored in the memory 112. Specifically, processor(s) 114 are programmed to execute computer-executable instructions for implementing aspects of the disclosure. Moreover, in some examples, the processor(s) 114 represent an implementation of analog techniques to perform the operations described herein.

Presentation component(s) 116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., an adapter) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128, such as the cloud-computing environment described in more detail below. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN): metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

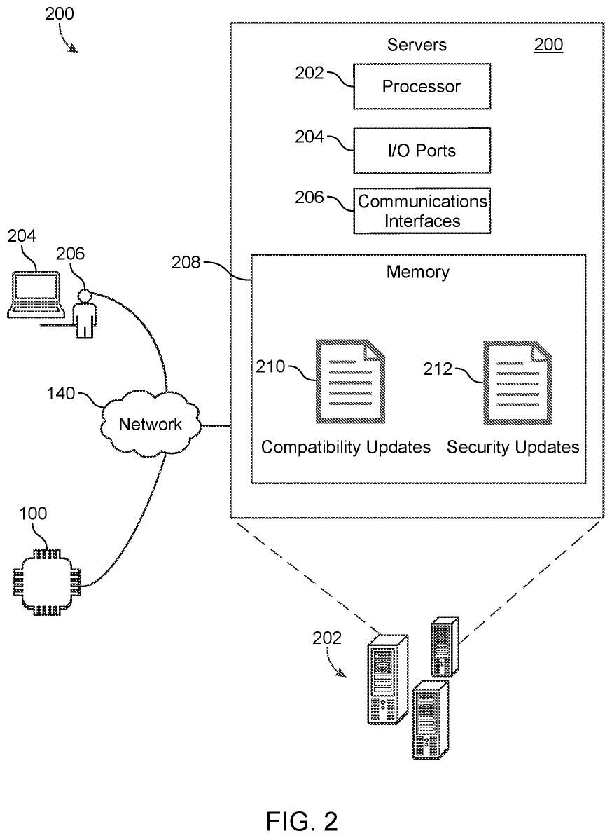

FIG. 2 illustrates a block diagram of a networking environment 200 for operating a cloud-connected embedded system (client device), according to some of the disclosed implementations. The networking environment 200 involves a client computing device 200 and a cloud environment 228 that communicate over network 230. In reference to FIG. 1, client device 100 represents an embedded system provisioned with the application VM 114 and the system VM 116 that are independently connected to their respective hardware components 110 (i.e., application hardware components 110a and system hardware components 110b, respectively).

A user 206 may connect to the cloud environment 200 and access data collected by the client device 100 using a computer 204. For example, the user 206 may view the current status of a smart appliance, monitor the performance of an industrial robot, check the status of a sensor on an oil well, or otherwise engage with any number of IoT devices. Any number of users 206, computers 204, and client devices (embedded systems) 100 may be accessible and use the networking environment 200.

Cloud environment 200 includes various servers 201 that may be any type of server or remote computing device, either as a dedicated, relational, virtual, private, public, hybrid, or other cloud-based resource. Servers 201 include a mixture of physical servers and VMs. Individually or collectively, servers 201 include or have access to one or more processors 202, I/O ports 204, communications interfaces 206, and computer-storage memory 208. Server topologies and processing resources are generally well known to those in the art, and need not be discussed at length herein, other than to say that any server configuration may be used to communicate with the client device 100 through receiving data therefrom and pushing updates thereto.

Memory 208 represents a quantity of computer-storage memory and memory devices that store executable instructions and data for use in hosting, monitoring, and managing the client devices 100. In some examples, memory 208 stores compatibility updates 210 and security updates 212 for the client device 100. The compatibility updates 210 include changes to the application code 122 that includes the application-specific functions for the client device 100 that are run in the application VM 114. The security updates 212 include security changes to the system code 126 that is run in the system VM 116. These changes are transmitted to the client device 100 over the network 140 and may be installed on the client device 100 by the update module 130.

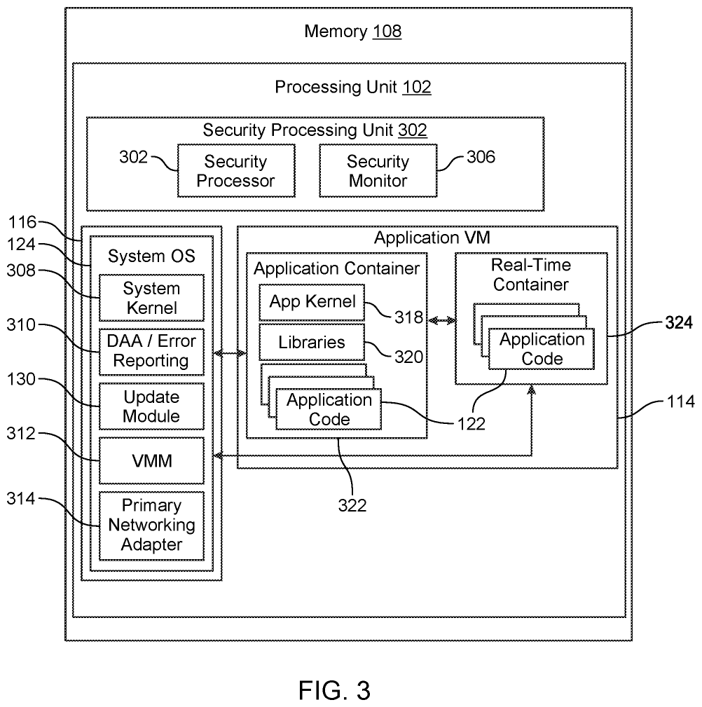

FIG. 3 illustrates a block diagram of the client device 100 with the partitioned application VM 114 and system VM 116, according to some of the disclosed implementations. The processing unit 102 is shown executing with the memory 108. Within the processing unit 102 and the memory 108, a security processing unit 302 is running along with the provisioned application VM 114 and the system VM 116.

The security processing unit 302 includes a security processor 304 and a security monitor 306. The system VM 116 includes the system OS 124 that, itself, includes a system kernel 308, device authentication and attestation (DAA) 310 that handles error reporting, the update module 130, a virtual machine manager (VMM) 312, and a primary networking adapter 314. The application VM 114 includes its own application kernel 318, one or more corresponding libraries 320, and various files that make up the application code 122. During operation, the security monitor 306 loads application code 122 from an application container 322 to a real-time container 324. The real-time container 324 represents the processing cores that run the application code 122.

To create the isolation between the system VM 116 and the application VM 114, the depicted OS architecture takes advantage of virtual machine technology and hardware firewalls to enforce strict isolation. The system OS 124 serves as the host and the application VM 114 runs as a virtual machine. Peripherals of the hardware components 110 are passed through directly to the application VM 114 to allow the application kernel 318 to control them. In some implementations, a few key peripherals, such as the primary networking adapter 314 and flash access, are para-virtualized to allow access as a shared resource between the system OS 124 and the application VM 114.

The application VM 114 hosts the core OS responsible for interfacing with hardware and running customer logic. In some implementations, the application VM 114 contains a full Linux instance, or other OS instance, that includes device builder customizations and applications. The application OS 120 provides numerous services to applications, including device drivers, support libraries 320, and security logic (such as process isolation).

Developers are able to start from an original image of the application kernel 318 and libraries 320 to make it easy to write new application (or application code 122). If they require more power, they can modify and customize the application OS 124 or replace it entirely with something like MICROSOFT AZURE® RTOS, ANDROID™, or a Silicon provider distribution. The developer are also to connect, or “pin,” to a specific version of the Azure Sphere distribution for maximum compatibility. Real-time cores (which executed in the disclosed real-time container 324 mentioned below) continue to provide time sensitive support as they do today, but with a more direct link to the application container 322 to allow for more coordination between device specific logic of the application code 122.

The system OS 124 serves as the core host of the client device 100 and provides system services and functionality based on the specific OS. The fact that customer applications (i.e., application code 122) no longer run directly in the system OS 124 allows for opportunities to simplify the application code 122. One example of this is the security policy, where many of the things that must be dynamic today to enable application scenarios are now fixed. Similarly, only shared peripherals like networking need to run in the system OS 124, which simplifies the kernel configuration and library needs.

Since primary networking is a shared resource, the primary networking adapter 324, and related functionality, remains in the system OS 124. In some implementations and examples, the application container 322 is presented with a para-virtualized ethernet adapter, much like traditional VM setups. Application code 122, however, is still needed to do things like scan for networks, configure credentials, and provide Internet Protocol (IP) settings. The virtual machine manager provides an existing guest to host IPC mechanism over a virtual socket that may be leveraged for this.

Like networking services, the system OS 124 must provide services for update. Some implementations and examples expose additional APIs to applications to better control update timing. This logic may also move to a virtual socket IPC between the application and the system OS 124.

The application container 322 is a VM. As a VM, the application container 322 includes a full kernel (app kernel 318) and user space file system comprising the libraries 320 in addition to the application code 122. Manufacturers of the client device 100 are in complete control of the application code 120 running in the application container 322. They can run a custom OS, or they can leverage existing code to build out their environment. The application container 322 has direct access to most peripherals to allow existing driver code to be used without modification. In some implementations, only a single application container 322 VM is created regardless of the number of applications running.

In some implementations, the real-time container 324 contains bare metal code that runs on microcontroller class compute cores. This allows customers to bridge the gap between traditional RTOS deployments and more-robust, proprietary OSes. Support for real time applications is a SoC specific feature and it is not expected to be uniform between SoCs. For example, one SoC might expose a general-purpose compute core such as an ARM Cortex-M while another SoC might expose a specialty DSP for audio processing. Processor manufacturers largely define the development experience for real time cores, focusing on cross-core communication and data sharing so that developers can build an end-to-end experience. For example, a sensor application running on a Cortex-M may gather data, do some simple batching, and then send it to an application on another core (e.g., HLOS) for network transmission.

Each SoC may define the role that a real time application plays in the overall hardware. A specialized DSP may only have access to a limited set of peripherals or logic while a more generic microcontroller core may be a general-purpose device.

Not all developers will want to fully customize the application OS in the application container 322. To help enable rapid development, implementations and examples provide an OS build that can be used as is or as a starting point for customer needs. The OS evolves over time, but customers will control the decision on when to update by rebuilding their applications. This enables them to “lock in” on a known working version and avoid the risk of an unexpected break. Similarly, the system OS 124 or application OS 120 may be open source so that customers can modify or extend the build as needed to meet their needs. Examples of this include adding libraries 320 to the file system, adding additional kernel modules to the application kernel 318, or the like.

One of the side effects of running two kernels is an increased memory (RAM) overhead. The app kernel 318 may be designed to be what is commonly referred to as a “micro VM,” changing the view on minimum platform requirements. In addition, processing units that use double data rate (DDR) may be used, bringing larger amounts of storage at similar price points.

Some SoC platforms may support both 32- and 64-bit code. In these implementations, developers are able to maintain control of what bit size they want to run. In addition, since this is entirely in the system OS 124, changes may be made over time. For example, first builds may be 32-bit and switched over 64-bit without impacting the application container 322.

Another piece of the hardware architecture to enable the OS design is related to direct memory access (DMA) engine usage. To enable peripherals of the hardware components 100 to natively run in the application container 322, DMA engines are also mapped to the application container 322. It is important that the DMA engine not be allowed access to system OS 124 memory 108, or shared resources, since it would not route through the virtualization memory protection mechanism and thus provide a VM escape opportunity.

To ensure the DMA engine has the right access control for the shared address space there are two approaches based on hardware capability. The first is to have the DMA engine use a unique identity on the firewall. This allows firewall rules to be programmed to disallow DMA access to System OS RAM and peripherals. On systems that have a memory management unit (MMU) integrated with the DMA engine this can be used to achieve the same results.

Hardware, both on the SoC and via external buses, are critical to IoT experiences. In traditional Linux OSes, some hardware is made easy to access but many physical interfaces are limited to highly privileged users and not optimized for performance. The average Linux deployment is primarily focused on storage, networking, and compute. The disclosed OS deployment build on this by additionally focusing on peripherals and data buses.

Hardware should largely be left in control of the device builder via kernel drivers and application code 122. Only shared resources, such as primary networking and storage, are mapped to system VM 124 partition. The SoC defines which peripherals can be used by specific domains. In some SoCs, peripherals may be able to map to multiple domains based on customer need. In other cases, hardware may be limited to just a single domain. Similarly, pin multiplexing differs among hardware offerings.

Isolation between the application VM 114 and the system VM 116 enables OS developers to be confident that their changes will not negatively impact developer applications or vice-versa. This approach allows for faster innovation by enabling developers to bring modifications and new code into the app container that they control. Security and functionality of the system OS 124 may continuously evolve without impact to the application running on the embedded system 100.

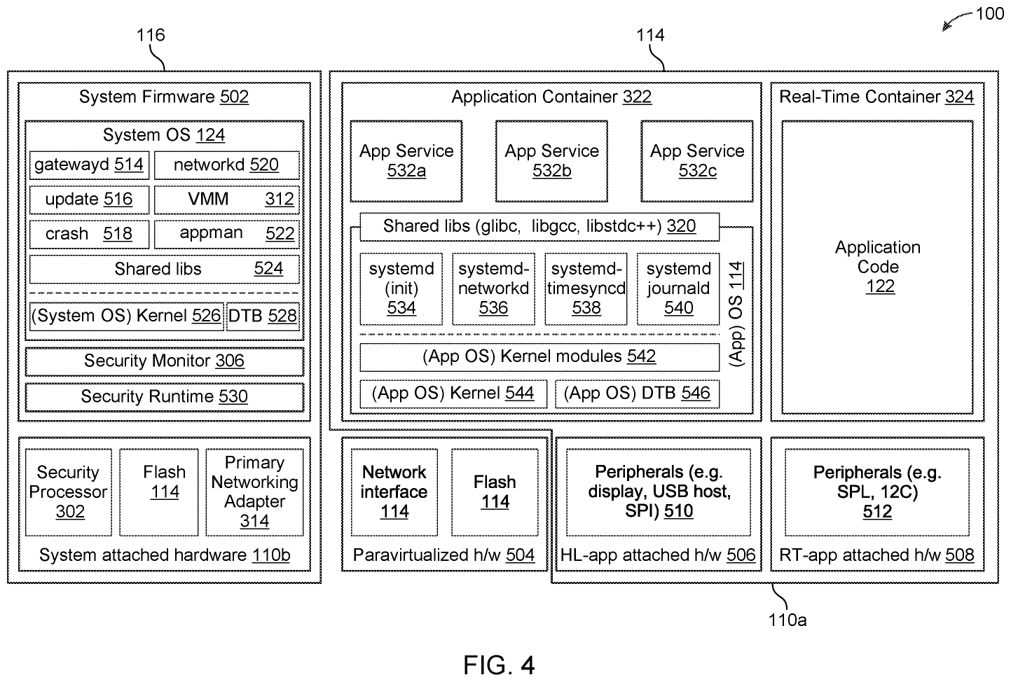

FIG. 4 illustrates a detailed block diagram of the client device 100 with a partitioned application VM 114 and system VM 116, according to some of the disclosed implementations. The depicted implementation shows the application VM 114 partitioned and isolated away from the system VM 116. The application VM 114 includes the application container 322. Processing cores execute the real-time container 324, where the application code 122 is actually executed. The system VM 116 includes system firmware 502 comprising the system OS 124.

Additionally, as illustrated, the client device 100 includes various types of hardware components 110 that are connected exclusively to either the system VM 116, the application VM 114, or are used by both. These include the system attached hardware, representing the previously discussed system hardware components 110b, para-virtualized hardware components 504, and application hardware components 110a. More specifically, the application hardware components 110a include those hardware components that are attached to the application container 322 and the real-time container 324, shown as HL-app attached h/w 506 and RT-app attached h/w 508, respectively. Each of these hardware components 110 are discussed in more detail below.

The system hardware components 110b includes the security processor 302, flash memory 114, and the primary network adapter 314. These various hardware components 110b are exclusively mapped and connected to the system VM 116, and are thus not usable by the application VM 114.

The application hardware components 110a include various peripherals 510 (e.g., a display, universal serial bus (USB) host, serial peripheral interface (SPI), and the like) that are used by the application partition 322. Other peripherals 512 (e.g., SPI, I2C, etc.) are connected to and used by the real-time container 324.

Moreover, some additional hardware components 110, paravirtualized h/w 504, may be used by both the application VM 114 and the system VM 116. Exposing only this small subset of hardware components 110 to the application VM 114 and the system VM 116 ensures that only a small number of hardware resources are impacted by both.

The system VM 116 includes the system firmware 502. The system firmware 502 includes the system OS 124 that comprises a number of kernel operations, APIs, and OS functions. Specifically, gatewayd 514 provides device communications for command and control. Software update support is provided through update module 516. Crash dumps and failure reporting is handled via crash module 518. Networkd 520 is the primary network device handles firewall management. The VMM 312 handles creation, editing, starting, stopping, and various other management operations of setting up the VMs discussed herein. An application manager (appman) 522 starts, stops, and monitors running applications. The system OS 124 uses various shared libraries 524, a kernel 526, a device tree blob (DTB) 528, the security monitor 306, and a security runtime 530. These operate together to provide a host OS (system OS 124) and security within the system VM 116.

Again, the application VM 116 includes the application container 322, and the real-time container 524 is executed on processing cores of the embedded system 100. The application container 322 various application services 532a-c, the libraries 320, a system 534, various system identifiers 534-540, kernel modules 542 for the application OS 120, a kernel 544 for the application OS 120, and a DTB 546 for the application OS 120. Moreover, the real-time container 522 is loaded with the application code 122 for the client device 100 (e.g., the instructions for the smart appliance to operate, computer vision for the industrial robot, telecommunication instructions for the security system, etc.). These operate together so that the application VM 114 is able to execute the application code 122 independent from the system OS 124.

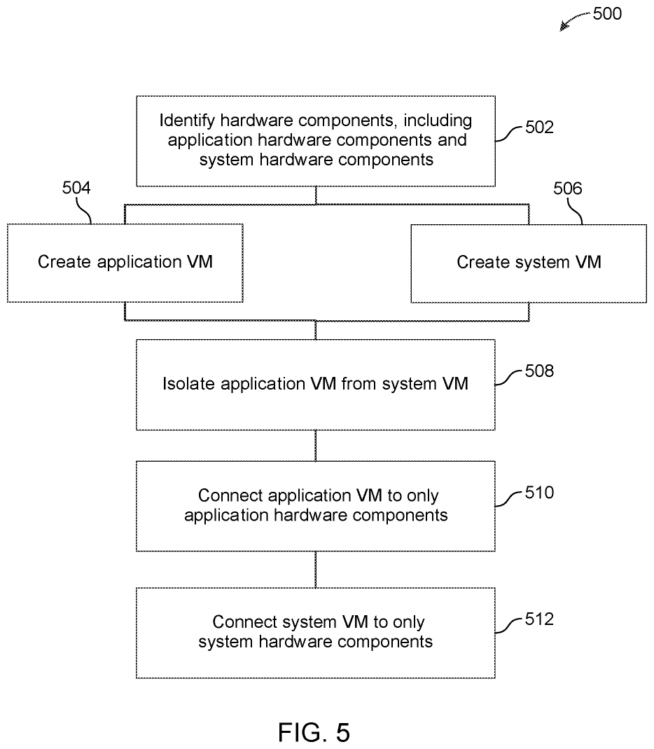

FIG. 5 illustrates a flow chart diagram detailing a workflow 500 for programming an embedded system with the application VM isolated from the system VM, according to some of the disclosed implementations. Hardware components on the embedded system are identified, as shown at 502. The hardware components include application hardware components and system hardware components. The application VM and the system VM are created, as shown at 504 and 506, respectively. The application VM is isolated from the system VM, as shown at 508. To do so, the application VM is only connected to the application hardware components, as shown at 510. And the system VM is only connected to the system hardware components, as shown at 512.

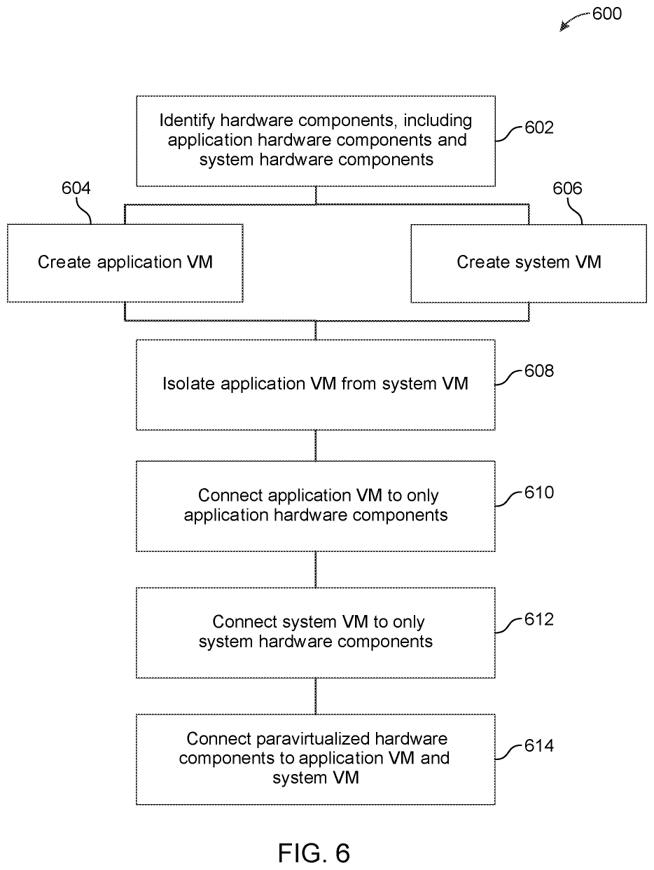

FIG. 6 illustrates a flow chart diagram detailing a workflow 600 for programming an embedded system with the application VM isolated from the system VM, according to some of the disclosed implementations. Hardware components on the embedded system are identified, as shown at 602. The hardware components include application hardware components and system hardware components. The application VM and the system VM are created, as shown at 604 and 606, respectively. The application VM is isolated from the system VM, as shown at 608. To do so, the application VM is only connected to the application hardware components, as shown at 610. And the system VM is only connected to the system hardware components, as shown at 612. Also, paravirtualized hardware is connected to both the application VM and the system VM, as shown at 614

### Additional Examples

Some examples are directed to an embedded system configured to perform application-specific instructions. The embedded system includes: a plurality of hardware components comprising system hardware components and application hardware components; memory embodied with instructions for creating an application VM in isolation from a system VM; and a processing unit configured to only connect the application hardware components to the application VM application hardware components and only connect the system hardware components to the system VM.

In some examples, the application VM comprises an application container that contains an application OS.

Other examples include: an application OS running exclusively in the application VM; and a system OS running exclusively in the system VM.

Other examples include paravirtualized hardware components that are usable by both the application VM and the system VM.

In some examples, the processing unit is at least one of a microprocessor.

In some examples, the processing unit is at least one of an SoC, MCU, or ASIC.

In some examples, the embedded system is an Internet of things (IoT) device.

In some examples, the application hardware components comprise at least one peripheral component.

In some examples, the system hardware components comprise at least one of a security processor, flash memory, or a primary network adapter.

Other examples are directed to an embedded system configured to perform application-specific instructions. The embedded system includes: a plurality of hardware components comprising system hardware components, application hardware components, and paravirtualized hardware components; memory embodied with instructions for creating an application virtual machine (VM) in isolation from a system VM; and a processing unit configured to: only connect the application hardware components to the application VM application hardware components, only connect the system hardware components to the system VM, and create a real-time container in the application VM for running application code to carry out the application-specific instructions.

Other examples include paravirtualized hardware components that are usable by both the application VM and the system VM.

In some examples, the processing unit is at least one of a microprocessor.

In some examples, the processing unit is at least one of a system on chip (SoC), microcontroller unit (MCU), or application-specific integrated circuit (ASIC).

In some examples, the embedded system is an Internet of things (IoT) device.

In some examples, the application hardware components comprise at least one peripheral component.

In some examples, the system hardware components comprise at least one of a security processor, flash memory, or a primary network adapter.

Other examples are directed to a method for programming an embedded system configured to perform application-specific instructions. The method includes: identifying a plurality of hardware components of the embedded system, the plurality of hardware components comprising application hardware components and system hardware components; creating an application virtual machine (VM) to run on the embedded system; creating a system VM to also run on the embedded system in isolation from the application VM; connecting the application VM to only the application hardware components; and connecting the system VM to only the system hardware components.

Other examples are directed to: receiving an update to a system operating system (OS) executing in the system VM; and updating the system OS in the system VM without updating software in the application VM.

While the aspects of the disclosure have been described in terms of various examples with their associated operations, a person skilled in the art would appreciate that a combination of operations from any number of different examples is also within scope of the aspects of the disclosure.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An embedded system configured to perform application-specific instructions, the embedded system comprising:
a plurality of hardware components comprising system hardware components and application hardware components;
memory embodied with instructions for creating an application virtual machine (VM) in isolation from a system VM; and
a processing unit configured to only connect the application hardware components to the application VM and only connect the system hardware components to the system VM.

2. The embedded system of claim 1, wherein the application VM comprises an application container that contains an application operating system (OS).

3. The embedded system of claim 2, wherein the application VM includes application code executable to perform the application-specific instructions.

4. The embedded system of claim 1, further comprising:
an application operating system (OS) running exclusively in the application VM; and
a system OS running exclusively in the system VM.

5. The embedded system of claim 1, further comprising paravirtualized hardware components that are usable by both the application VM and the system VM.

6. The embedded system of claim 1, where the processing unit is at least one of a microprocessor.

7. The embedded system of claim 1, wherein the processing unit is at least one of a system on chip (SoC), microcontroller unit (MCU), or application-specific integrated circuit (ASIC).

8. The embedded system of claim 1, wherein the embedded system is an Internet of things (IoT) device.

9. The embedded system of claim 1, wherein the application hardware components comprise at least one peripheral component.

10. The embedded system of claim 1, wherein the system hardware components comprise at least one of a security processor, flash memory, or a primary network adapter.

11. An embedded system configured to perform application-specific instructions, the embedded system comprising:
a plurality of hardware components comprising system hardware components, application hardware components, and paravirtualized hardware components;
memory embodied with instructions for creating an application virtual machine (VM) in isolation from a system VM; and
a processing unit configured to:
only connect the application hardware components to the application VM application hardware components,
only connect the system hardware components to the system VM, and
create a real-time container in the application VM for running application code to carry out the application-specific instructions.

12. The embedded system of claim 11, further comprising:
an application operating system (OS) running exclusively in the application VM; and
a system OS running exclusively in the system VM.

13. The embedded system of claim 11, further comprising paravirtualized hardware components that are usable by both the application VM and the system VM.

14. The embedded system of claim 11, where the processing unit is at least one of a microprocessor.

15. The embedded system of claim 11, wherein the processing unit is at least one of a system on chip (SoC), microcontroller unit (MCU), or application-specific integrated circuit (ASIC).

16. The embedded system of claim 11, wherein the embedded system is an Internet of things (IoT) device.

17. The embedded system of claim 11, wherein the application hardware components comprise at least one peripheral component.

18. The embedded system of claim 11, wherein the system hardware components comprise at least one of a security processor, flash memory, or a primary network adapter.

19. A method for programming an embedded system configured to perform application-specific instructions, the method comprising:
identifying a plurality of hardware components of the embedded system, the plurality of hardware components comprising application hardware components and system hardware components;
creating an application virtual machine (VM) to run on the embedded system;
creating a system VM to also run on the embedded system in isolation from the application VM;
connecting the application VM to only the application hardware components; and
connecting the system VM to only the system hardware components.

20. The method of claim 19, further comprising:
receiving an update to a system operating system (OS) executing in the system VM; and
updating the system OS in the system VM without updating software in the application VM.
